(19) United States
(12) Patent Application Publication
(10) Pub. No.: US 2020/0309264 A1
(43) Pub. Date: Oct. 1, 2020

(54) DEVICE FOR CLAMPING A STUFFING BOX PACKING

(71) Applicant: BHS-Sonthofen GmbH, Sonthofen (DE)

(72) Inventors: Bernhard Kienle, Oberstaufen (DE); Lukas Elässer, Ofterschwang (DE); Detlef Steidl, Ofterschwang (DE); Jürgen Maurer, Immenstadt (DE); Wolfgang Süss, Sonthofen (DE)

(21) Appl. No.: 16/765,567

(22) PCT Filed: Oct. 9, 2018
(86) PCT No.: PCT/EP2018/077394

§ 371 Date: May 20, 2020

(30) Foreign Application Priority Data
Nov. 24, 2017 (DE) 10 2017 221 088.5

(51) Int. Cl. F16J 15/18

(52) U.S. Cl. CPC F16J 15/185

(57) ABSTRACT

A device for tensioning a stuffing box packing includes a plurality of clamping elements, which press a stuffing box gland against the stuffing box packing and thus press the stuffing box packing against a superordinate assembly. At least two clamping elements are connected in a torque-transmitting manner such that rotation of one of the clamping elements causes rotation of the other clamping element or elements.

The invention relates to a device for clamping a stuffing box packing.

The applicant has been selling rotary pressure filters for many years. In the case of such rotary pressure filters, the process spaces which are subjected to overpressure are usually sealed off from the environment by a stuffing box packing between the rotating filter drum and the filter housing. In order to be able to reliably ensure sealing even after a long operating period, the stuffing box packing must be retightened at regular intervals. The result of retightening and thus the quality of the seal strongly depends on the experience and careful work of the operating personnel.

Due to the decreasing elasticity of the stuffing box packing material and wear of stuffing box packing on the sliding surface to the filter drum, the clamping elements of the gland have to be retightened at regular intervals to maintain the sealing effect of the packing.

The clamping elements of the stuffing box packing are often only retightened at points on the circumference where leakage is noticed, and not according to the operating instructions at all clamping elements with the same path. This can cause the stuffing box gland to tilt and, in the worst case, to damage the surface of the filter drum.

It is therefore the object of the present invention to remedy these problems.

This object is achieved by a device for clamping a stuffing box packing, in particular a stuffing box packing of a rotary pressure filter, comprising the stuffing box packing, which is positioned against a superordinate assembly to be sealed by the stuffing box packing and does not belong to the device, a stuffing box gland, which is positioned against a free side of the stuffing box packing, a plurality of clamping elements, which press the stuffing box bland against the stuffing box packing and thus press the stuffing box packing against the superordinate assembly, at least two clamping elements being connected in a torque-transmitting manner such that rotation of one of the clamping elements causes rotation of the other clamping element or elements.

The device according to the invention can prevent that only individual clamping elements are retightened, so that inclined positioning of the stuffing box gland can be avoided, and the stuffing box packing can be axially mechanically acted upon with the correct contact pressure via the stuffing box gland.

An appropriate interface can be provided on the device for this retightening. For example, one of the clamping elements can be designed such that it can be caused to engage with a tool such as a torque wrench. A typical torque to be set on the torque wrench for such applications is approximately 330 Nm, for example. Upon rotation of the tool, this clamping element and all clamping elements connected to this clamping element in a torque-transmitting manner are set in rotation.

The stuffing box packing can comprise a plurality of stuffing box packing rings.

The stuffing box packing or the stuffing box packing rings can be made of braided PTFE fibre material, for example. Due to the braiding structure, the axial tension of the stuffing box packing or stuffing box packing rings can also generate a radial force between the stuffing box packing and the rotating filter drum and to the filter housing, which can effect the sealing effect against the internal pressure.

The clamping elements can be made of metal, for example, in particular steel with the material designation 1.4462.

In one refinement of the invention, all clamping elements of the device can be connected to one another in a torque-transmitting manner such that rotation of one of the clamping elements causes rotation of all the other clamping elements. This means that all clamping elements are coupled to one another, and no clamping element can be retightened inconsistently with respect to the others or even forgotten during retightening.

Advantageously, the clamping elements connected in a torque-transmitting manner can be connected via at least one chain or belt. The clamping elements can comprise at least one wheel, for example a gearwheel, with which the chain or belt meshes. In the event that more than one chain or more than one belt is to be engaged with a clamping element, a clamping element can also comprise more than one wheel. For example, a chain can connect two adjacent clamping elements, whereby for this purpose each clamping element, viewed in the direction of an axis of rotation of the clamping element, can comprise two gearwheels arranged one behind the other. In particular, in the event that the angular distances between the axes of the clamping elements are equal, but 360° is not a multiple of a single angular distance, that is, if several identical angular distances cannot be added up to equal 360°, for example to be able to use chains or belts of a certain length/size, a pair of adjacent clamping elements can be free of a torque transmitting connection. This is the case, for example, with an angular distance of 32°. Of course, this also applies to angular distances that are different from one another. This free space can also be provided, for example, for access to the rotary pressure filter with a flushing lance or the like.

In particular, chains can be insensitive to temperature, moisture and dirt.

The chains can be made of metal, for example, in particular stainless steel.

In order to keep the tension of the chains or belts constant, even after an elongation caused by operation, it can be advantageous to provide a chain or belt tensioner, via which the tension can be adjusted automatically or manually. The chains can also run without pretension, however.

Alternatively or additionally, a centre distance and a pitch circle of the wheels of the clamping elements, on which the axes of rotation of the clamping elements are arranged, and the number of links of the individual chains can be coordinated with one another such that no chain or belt tensioners are required.

In one refinement of the present invention, all clamping elements can be connected to one another via a single chain or a single belt. The chain or the belt can engage with the clamping elements with respect to the pitch circle of the clamping elements, in each case on their radially outer side. However, the chain or belt can also alternately engage with an inner and an outer side of the clamping elements or of the wheels of the clamping elements in the form of a circular serpentine line. The chain pitch and number of teeth in the wheels of the clamping elements can be selected such that better wrapping of the wheels through the chain and thus better power transmission is achieved than in the case of a chain that merely lies radially on the outside of the clamping elements.

The clamping elements can be divided into at least two subgroups, clamping elements are only connected in a torque-transmitting manner to clamping elements of the same subgroup. Accordingly, it may be necessary for at least one interface with a tool, such as the torque wrench mentioned above, to be provided for each subgroup. The division into subgroups can have the advantage that individual areas of the stuffing box gland can be retightened separately and that a friction force generated by the individual clamping elements and the chains or belts connecting them that has to be overcome during the retightening process can be reduced.

The clamping elements can advantageously be designed as nuts which can be displaced on a stud. The studs can, for example, be screwed into a housing of the printer filter. The stuffing box gland can then be attached to these studs, the studs protruding through the gland. The clamping elements designed as nuts can now be screwed onto the studs until they press the stuffing box gland against the stuffing box packing with a predefined force.

The nuts and the studs can also be tolerated in length and have a central bore, which means that a depth gauge can be used to precisely adjust the parallelism of the individual wheels to one another. The theoretical maximum deviation would be one half of a division on the wheel. If, for example, a nut has a gearwheel with 15 teeth, a thirtieth turn of the nut or gearwheel with a thread pitch of 2 mm results in a movement of 0.07 mm in the axial direction of the nut or stud.

The nuts can be made of metal, for example, in particular steel in particular with the material designation 1.4462.

The studs can be provided with a support surface. On the one hand, this can increase the stability of the studs in the housing of the rotary pressure filter and, on the other hand, can ensure an exact overhang, i.e. an installation length for corresponding add-on parts, such as the stuffing box gland.

As an alternative or in addition to the torque-transmitting connection of the clamping elements, the clamping elements can be connected to a toothed ring such that rotation of the toothed ring causes rotation of the clamping elements connected thereto. Analogous to the ring gear of a planetary gear, the toothed ring can mesh with the gearwheels of the clamping elements. As with a planetary gear with fixed planet gears, a rotation of the toothed ring can cause a synchronised rotation of the clamping elements, so that all clamping elements, for example in the case of the above-mentioned design of the clamping elements as a nut and stud, can be moved together in an axial direction towards or away from the stuffing box packing.

It is also possible for only part of the toothed ring to be embodied with teeth. Thus, for example, a ring gear can be provided with teeth only at predetermined locations, the teeth then being connected to the gearwheels of the clamping elements.

The toothed ring can also be embodied in several parts. In this way, assembly of the toothed ring on the clamping elements can be simplified such that the toothed ring can first be brought into engagement with the clamping elements and then joined, for example pinned or riveted, to form a complete toothed ring gear ring.

The device can further comprise a motor which drives a clamping element. The motor can be designed, for example, to be able to be brought into engagement with the interface for manual retightening. In this way, existing systems can be retrofitted with such a motor. Manual retightening can be omitted by providing the motor. Of course, the motor can be set, i.e. limited, to a desired maximum torque.

In one refinement of the present invention, the device can comprise a measuring device which is designed to measure a force that is transmitted from the clamping elements to the stuffing box packing via the stuffing box gland. This can be done in at least one of the following ways, for example:

For one thing, an axial contact pressure of an innermost stuffing box packing ring to a stuffing box packing shoulder, i.e. of a stuffing box packing ring furthest from the stuffing box gland to a shoulder of the housing, against which this stuffing box packing ring is positioned can be measured. For another thing, an axial contact pressure of the stuffing box gland to the stuffing box packing can be measured. In addition, pre-tensioning of the clamping elements, in particular the nuts and studs, can be detected by the measuring device. However, the distance of the tightening path on the stuffing box gland can also be measured.

Knowing the force that is transmitted from the clamping elements to the stuffing box packing via the stuffing box gland can prevent in particular excessive retightening of the clamping elements, for example using the output of a corresponding warning signal or by switching off the motor. For example, if the retightening is too strong, the material of the stuffing box packing is highly compressed and loses its elasticity. If there are leaks, they cannot be eliminated by further retightening.

The device can also be designed to drive via the motor the clamping element connected thereto if a predetermined threshold value of the force measured by the measuring device is reached or not attained. One cause of damage or failure of the stuffing box packing can in particular also be failure to retighten the stuffing box packing in time. As a result, the contact pressure on the stuffing box packing falls below the process pressure, so that filtration material can penetrate into the space in the stuffing box packing. Individual stuffing box packing rings can rotate with the filter, so that large gaps can be created and the stuffing box packing can fail completely.

In addition to using the measured force, detection of leaks, for example via level switches in the end shield, can also activate the motor.

A sliding element can advantageously be arranged between the clamping elements and the stuffing box gland. The friction force to be overcome between the clamping element and the stuffing box gland when retightening the clamping elements can be reduced in this manner. Furthermore, wear and thus a change in the dimensions of the clamping elements and/or of the stuffing box gland can be reduced or even completely avoided.

A gear, in particular a reduction gear, can be arranged on at least one of the clamping elements. In this way, a force to be introduced into the device, for example at the interface, for retightening the clamping elements can be less than a force applied to the clamping elements via the connecting elements, for example the chain(s). This can be particularly advantageous in the case of rotary pressure filters, which work with a high overpressure and thus require a high contact pressure of the stuffing box packing.

The invention will be explained in greater detail below on the basis of exemplary embodiments with reference to the accompanying drawings.

In the drawings:

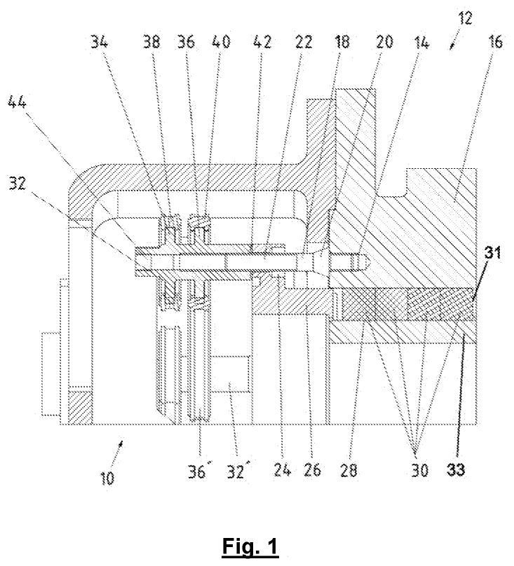

FIG. 1 is a lateral sectional view of a section of a rotary pressure filter equipped with an embodiment of the inventive device;

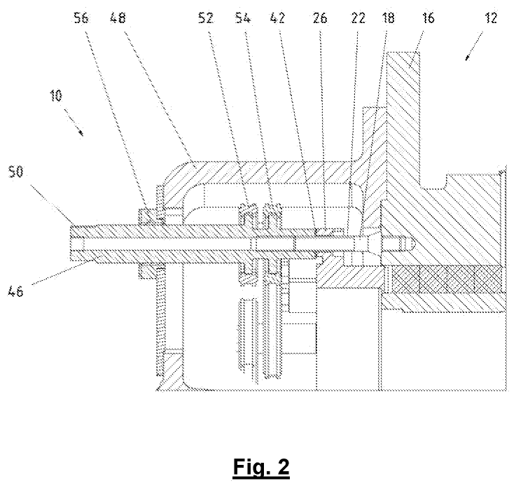

FIG. 2 is a lateral sectional view of a further section of the rotary pressure filter and the inventive device according to FIG. 1;

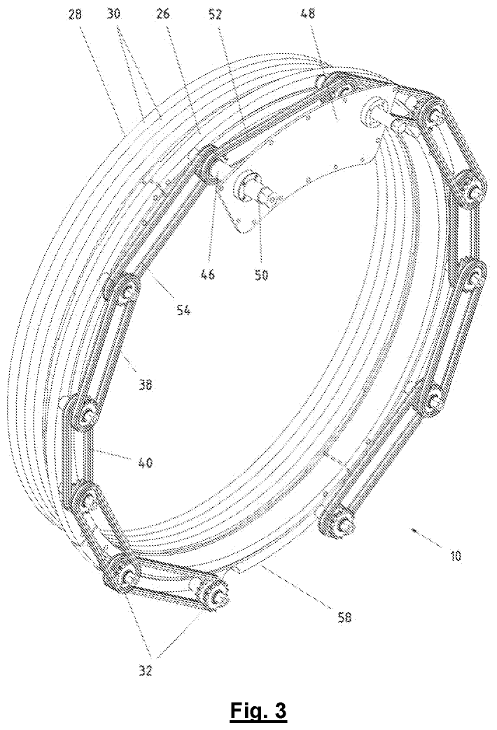

FIG. 3 is a perspective elevation of the embodiment of the inventive device according to FIGS. 1 and 2;

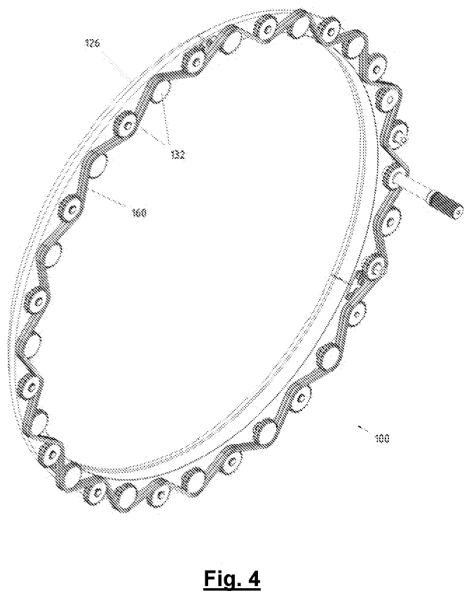

FIG. 4 is a perspective elevation of a second embodiment of the inventive device;

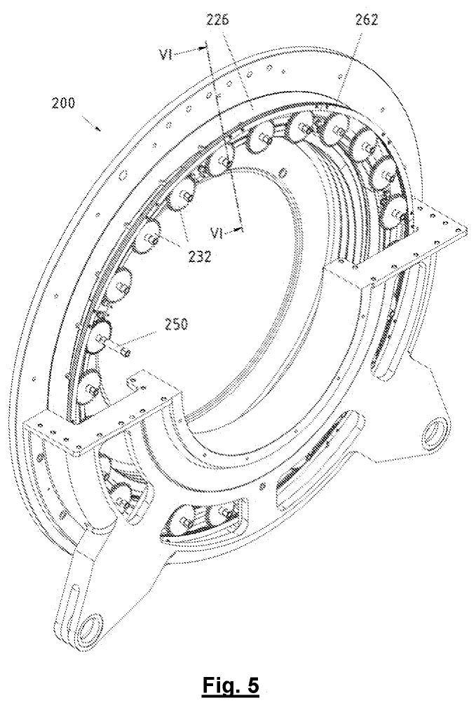

FIG. 5 is a perspective elevation of a third embodiment of the inventive device;

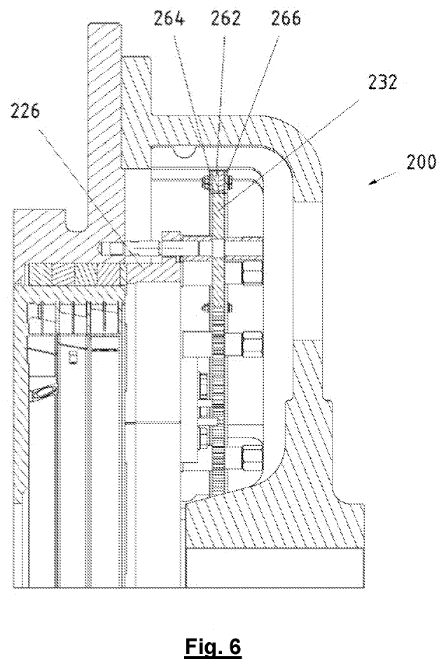

FIG. 6 is a lateral sectional view of a detail of the embodiment according to FIG. 5.

In FIG. 1, an embodiment of the inventive device, which is installed in a rotary pressure filter 12, is designated 10 overall. A stud 18 is screwed into a threaded hole 14 of a housing 16 of the rotary pressure filter 12. The stud 18 has a shoulder 20 that is positioned against the housing 16 when the stud 18 is completely screwed in. A male thread 22 of the stud 18 projects through a through-hole 24 of a stuffing box gland 26. The stuffing box gland 26 is designed such that it presses against a stuffing box packing 28, which in this case comprises a plurality of stuffing box packing rings 30. On the side of the stuffing box packing 28 opposite the stuffing box gland 26, the former is positioned against a stuffing box packing shoulder 31. A clamping element 32 is screwed onto the male thread 22 of the stud 18 and is embodied here as a nut. The nut 32 comprises two gearwheels 34 and 36, also called “roller chain wheels,” the gearwheel 34 being located further away in an axial direction of the stud 18 and the nut 32 with respect to the stuffing box gland 26, i.e. further to the outside, than the gearwheel 36. The outer gearwheel 34 meshes with an outer chain 38, and the inner gearwheel 36 meshes with an inner chain 40.

It can be seen in FIG. 1 that the inner chain 40 connects the nut 32 shown in section in FIG. 1 to an inner gearwheel 36′ of an adjacent clamping element 32′. The outer chain 38 connects the nut 32 to a clamping element (not shown in FIG. 1) adjacent on the other side. Rotation of the nut 32 is transmitted from the two chains 38 and 40 in a synchronised manner to the adjacent clamping element 32′ and to the clamping element (not shown) adjacent on the other side. When the nut 32 is rotated correspondingly on the stud 18, the latter is displaced on the male thread 22 of the stud 18 in the direction of the housing 16 of the rotary pressure filter 12. This displacement causes the nut 32 to exert force on the stuffing box gland 26 and, via the latter, to exert force on the stuffing box packing 28. The stuffing box packing 28 is then pressed towards the stuffing box packing shoulder 31, whereupon the stuffing box packing 28 bulges radially inwards against a filter drum 33.

When connecting the clamping elements 32 to the chains 38, 40, doing so should begin with an inner chain 40 for reasons of accessibility. To this end, a pair of clamping elements 32 should first be set to the same height, then the chain 40 should be placed over the clamping elements 32 and connected by means of a lock. After all of the inner chains 40 are assembled, the outer chains 38 can be assembled.

To reduce the coefficient of friction between the nut 32 and the stuffing box gland 26, a sliding element 42 in the form of a sliding disc is arranged between the nut 32 and the gland 26.

The nut 32 in this case has a through-hole 44. Through this through-hole 44, a depth gauge can measure how far the nut 32 is screwed onto the stud 18. To this end, both the stud 18, in particular the distance from the shoulder 20 to an opposite end of the stud 18, and a corresponding overall length of the nut 32 should have close tolerances and be known.

FIG. 2 shows a further section of the inventive device 10 or of the rotary pressure filter 12 according to the embodiment shown in FIG. 1. Therefore, please refer explicitly to the description of FIG. 1. Parts analogous to FIG. 1 are provided with the same reference numbers in FIG. 2 as in FIG. 1. A stud 18 can also be seen in FIG. 2 and is screwed into the housing 16 of the rotary pressure filter 12. A clamping element 46 is screwed onto the male thread 22 of the stud 18 and presses on the stuffing box gland 26 via a sliding ring washer 42. Analogously to the clamping element 32, the clamping element 46 is also designed as a nut, the part of the nut 46 opposite the part screwed onto the male thread 22 of the stud 18 projecting outwards through a protective cover 48 of the device 10.

At the outwardly projecting end of the nut 46, an interface 50 is provided, at which an operator of the device 10 can apply a tool, such as a torque wrench. Alternatively or additionally, a motor (not shown), such as an electric motor, can act on the interface 50.

As already described with reference to FIG. 1, a rotation of the nut 46 is transmitted to adjacent clamping elements via an outer chain 52 or an inner chain 54. For further support, the nut 46 is mounted in the protective cover 48 via a slide bearing bush 56.

The embodiment of the inventive device 10 described in FIGS. 1 and 2 is shown in FIG. 3 absent the other components of the rotary pressure filter 12. Here, the stuffing box packing 28 or its rings 30 can be seen, the stuffing box gland 26 resting against one side thereof. Distributed over the stuffing box gland 26 are twelve clamping elements 32, one of which is designed as a clamping element provided with an interface 50, in the sense of the clamping element 46 from FIG. 2. The clamping elements 32 and 46 are each connected in pairs via chains, as shown in FIGS. 1 and 2 by the outer chains 38 and 52 and the inner chains 40 and 54. In FIG. 3, two outer chains with the reference numbers 38 and 52 and two inner chains with the reference numerals 40 and 54 are provided by way of example.

It can be clearly seen in FIG. 3 that a rotation of the clamping element 46 is transmitted via the chains 38, 40, 52, 54 to each further clamping element 32 in a synchronised manner. At a point 58 of the device 10, no chain is provided between two adjacent clamping elements 32. On the one hand, this allows inclusion of a “remainder” of the difference of 360° minus the sum of the angular distances when using angular distances between the axes of the clamping elements 32 that do not add up to 360°, and, on the other hand, it also allows free access to the rotary pressure filter 12 a flushing lance. A section of the protective cover 48 through which the clamping element 46 extends can also be seen in FIG. 3.

FIG. 4 shows a second embodiment 100 of the inventive device 10 according to FIGS. 1 through 3. Components in FIG. 4 similar to those of FIGS. 1 through 3 are shown with the same reference numbers, but increased by the number 100. With regard to the second embodiment 100, reference is explicitly made to the embodiment of the inventive device 10 according to FIGS. 1 through 3. In FIG. 4, thirty-two clamping elements 132 are evenly distributed across a stuffing box gland 126. A single continuous chain 160 is arranged on the clamping elements 132 such that it wraps alternately around a radially inner and a radially outer section of a clamping element 132 for the stuffing box gland 126.

Of course, the chain 160 could also be placed in a circular shape across all the radially outer sections of the clamping elements 132 for the stuffing box gland 126. However, the degree of wrap and thus the surface area of force transmission, i.e. the number of teeth of a wheel of a clamping element 132 that are engaged with the chain 160, is greater in the manner in which the chain 160 is placed as shown in FIG. 4.

FIG. 5 shows a further embodiment 200 of the inventive device 10 according to FIGS. 1 through 3 or the inventive device 100 according to FIG. 4. Components in FIG. 5 similar to those of FIGS. 1 through 4 are shown with the same reference numbers, but increased by the number 200 or increased by the number 100 with respect to FIG. 4. With regard to embodiment 200, reference is explicitly made to the embodiment of the inventive device 10 according to FIGS. 1 through 3 and the embodiment of the inventive device 100 according to FIG. 4. In FIG. 5, twenty-four clamping elements 232 are arranged on a stuffing box gland 226. As in the embodiments 10 and 100, the clamping elements 232 comprise gearwheels in this case, as well. The radially outer sections of the clamping elements 232 for the gland 226 are engaged with a toothed ring 262 that is designed as an internally toothed ring. One of the clamping elements 232 in FIG. 5 is provided with an interface 250, in the sense of the nut 46 from FIG. 2. A rotation of one of the clamping elements 232 is transmitted via the toothed ring 262 to all other clamping elements 232, so that they always rotate synchronously.

In FIG. 6, the embodiment 200 according to FIG. 5 is shown in section according to section line VI-VI. It can be seen that the gearwheel of the clamping element 232 is connected to the toothed ring 262.

In order to prevent the toothed ring 262 from separating from the gearwheels of the clamping elements 232, the toothed ring 262 has two radially inwardly projecting collars 264 and 266 that engage the gearwheels of the clamping elements 232. The collar 264 of the toothed ring 262 is arranged on a side of the gearwheel facing the stuffing box gland 226, and the collar 266 is arranged on an opposing side of the gearwheel facing away from the stuffing box gland 226.

1. A device for tensioning a stuffing box packing, in particular a stuffing box packing of a rotary pressure filter, comprising the stuffing box packing, which is positioned against a superordinate assembly to be sealed by the stuffing box packing and does not belong to the device, a stuffing box gland which is positioned against a free side of the stuffing box packing, a plurality of clamping elements, which press the stuffing box the gland against the stuffing box packing and thus press the stuffing box packing against the superordinate assembly, wherein at least two clamping elements being connected in a torque-transmitting manner such that rotation of one of the clamping elements causes a rotation of the other clamping element or elements.

2. The device according to claim 1, wherein all the clamping elements of the device are connected to one another in a torque-transmitting manner such that rotation of one of the clamping elements causes rotation of all other clamping elements.

3. The device according to claim 2, wherein the clamping elements connected in a torque-transmitting manner are connected via at least one chain or belt.

4. The device according to claim 3, wherein all clamping elements are connected to one another via a single chain or a single belt.

5. The device according to claim 1, wherein the clamping elements are divided into at least two sub-groups, wherein clamping elements are only connected to clamping elements of the same sub-group in a torque-transmitting manner.

6. The device according to claim 1, wherein the clamping elements are designed as nuts which can be displaced on a stud screw.

7. The device according to claim 1, wherein at least one of the clamping elements are connected to a toothed ring such that rotation of the toothed ring causes rotation of the at least one clamping element connected thereto.

8. The device according to claim 1, wherein the device further comprises a motor which drives at least one of the clamping element.

9. The device according to claim 1, wherein the device comprises a measuring device which is designed to measure a force that is transmitted from the clamping elements to the stuffing box packing via the stuffing box gland.

10. The device according to 8 claim 9, wherein the device is designed to drive via the motor the at least one clamping element connected thereto if a predetermined threshold value of the force measured by the measuring device is reached or not attained.

11. The device according to claim 1, wherein a sliding element is arranged between the clamping elements and the stuffing box gland.

12. The device according to claim 1, wherein a gear, in particular a reduction gear, is arranged on at least one of the clamping elements.

13. The device according to claim 1, wherein the at least two clamping elements connected in a torque-transmitting manner are connected via at least one chain or belt.
